(19) United States
(12) Patent Application Publication
(10) Pub. No.: US 2024/0290965 A1
(43) Pub. Date: Aug. 29, 2024

(54) THIN FILM METAL AND METAL OXIDE ANODES FOR RECHARGEABLE BATTERIES

(71) Applicant: UCHICAGO ARGONNE, LLC, Chicago, IL (US)

(72) Inventors: Michael J. Counihan, Downers Grove, IL (US); Sanja Tepavcevic, Chicago, IL (US); Pallab Barai, Bolingbrook, IL (US); Venkat Srinivasan, Naperville, IL (US); Anil U. Mane, Naperville, IL (US); Rajesh Pathak, Westmont, IL (US); Jeffrey W. Elam, Elmhurst, IL (US)

(73) Assignee: UCHICAGO ARGONNE, LLC, Chicago, IL (US)

(21) Appl. No.: 18/437,163

(22) Filed: Feb. 8, 2024

Related U.S. Application Data
(60) Provisional application No. 63/447,809, filed on Feb. 23, 2023.

(51) Int. Cl. H01M 4/525; H01M 4/505; H01M 10/0525; H01M 10/0569

(52) U.S. Cl. CPC H01M 4/525; H01M 4/505; H01M 10/0525; H01M 10/0569

(57) ABSTRACT

A discharged electrochemical cell as described herein comprises an electrochemically reactive metal-containing cathode (e.g., Li, Na, Mg, or Zn; preferably Li) and a layered anode with an electrolyte therebetween. The layered anode comprises a conductive substrate and a reactive film of a metal, a semimetal, a metal oxide, or a semimetal oxide on the surface of the substrate. The reactive film is capable of reversibly alloying with, reversibly forming a mixed phase with, or reversibly reacting with, metal from cathode during charging of cell, and releasing the metal back to the cathode during discharge of the cell.

### CROSS-REFERENCE TO RELATED APPLICATIONS

This application claims the benefit of U.S. Provisional Application Ser. No. 63/447,809, filed on Feb. 23, 2023, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to anodes for rechargeable batteries.

### BACKGROUND OF THE INVENTION

Solid-state lithium metal batteries, especially “anode-free” configurations (i.e., configurations in which a metal foil (e.g., Cu foil) is sole counter electrode), are a promising technology for high energy density systems like electric vehicles. However, the formation of lithium dendrites creates safety challenges, and the efficiency of these systems is limited without high applied pressure.

One prior solution for maintaining high-capacity lithium anodes is using elements that alloy with lithium at low potentials. This can involve semimetals like Si, Ge, or B or metals like Mg, Al, Ga, Sn, In, Ag, Au, Pt, Zn, Pb, or Bi. The lithium is incorporated in the host material, forming distinct phases (i.e., LiAl, Li₃Bi, Li₂₂Si₅, etc.). The insertion of Li atoms into the host material results in expansion of the metal to various degrees, sometimes up to 400% as in the case of Si. This causes drastic volume changes in the battery that lead to capacity fade over time, especially in solid-state batteries. Additionally, all alloys have higher potentials and lower gravimetric capacity than pure Li metal, resulting in lower battery energy density. Finally, many reported alloy-based anodes require pre-lithiation of the material, which can be challenging and costly.

Because of the aforementioned challenges there is an ongoing need for alternative rechargeable battery configurations. The electrochemical cells described herein address this need.

### SUMMARY OF THE INVENTION

A discharged electrochemical cell as described herein comprises an electrochemically reactive metal-containing cathode (e.g., containing Li, Na, Mg, or Zn; preferably Li) and a layered anode with an electrolyte therebetween. The layered anode comprises an electrically conductive substrate (i.e., a current collector) and a reactive film comprising an elemental metal, an elemental semimetal, a metal oxide, or a semimetal oxide on the surface of the substrate. Optionally, the elemental metal or semimetal of the reactive film can be a pure metal or semimetal, or can be an alloy with a metal that does not alloy with the metal of the cathode. Similarly, the metal or semimetal oxide of the reactive film can be an oxide of a single metal or semimetal or can be an oxide of two or more metals or semimetals. The reactive film is capable of reversibly alloying with, reversibly forming a mixed phase with, or reversibly reacting with, the electrochemically reactive metal from the cathode during charging of cell, and releasing the electrochemically reactive metal back to the cathode during discharge of the cell. In the case of metal thin film anodes, the metal of the anode differs from the electrochemically reactive metal of the cathode (e.g., when the cathode comprises lithium metal, the elemental thin film of the anode comprises a semimetal or a metal other than lithium).

In some preferred embodiments, the electrochemically reactive metal-containing cathode comprises lithium (e.g., a lithium foil or a lithium-containing cathode material such as a lithium nickel-manganese-cobalt oxide (NMC)). The electrolyte comprises cations corresponding to cations of the electrochemically reactive metal of the cathode (i.e., for a lithium cathode, the electrolyte comprises lithium ion, for a sodium cathode, the electrolyte comprises sodium cations, and the like). The reactive film preferably has a thickness of about 1 nm to about 100 nm. In some embodiments the substrate (current collector) of the anode preferably is a metal foil or metal mesh, such as copper foil or copper mesh.

The reactive thin film can be deposited onto a current collector with whatever microstructure or morphology is desired by well-known deposition methods. In some embodiments, the reactive thin film comprises an elemental metal or semimetal. Suitable metals and semimetals include B, Mg, Al, Ca, Zn, Ga, Ge, As, Sr, Rh, Pd, Ag, Cd, In, Sn, Sb, Te, Ba, Ir, Pt, Au, Hg, Tl, Pb, and Bi. In some embodiments, the reactive film comprises a metal selected from the group consisting of Mg, Al, Ga, Sn, In, Ag, Au, Pt, Zn, Pb, and Bi. Low-cost, low-weight metals such as Al and Zn, or ultra-low amounts of high-performance metals such as Ag can be used as metal of the reactive thin film, depending on cost and performance features required for a given application or use. The metal or semimetal of the reactive thin film can also be part of an alloy with a metal that does not, by itself, alloy with the metal of the cathode, e.g., lithium. For example, the reactive thin film can be a Zn/Cu alloy (i.e., a brass) in which the Zn phase alloys with a cathode metal, such as lithium, during charging. Similarly, thin films of low cost metal oxides or semimetal oxides such as aluminum oxide and lithium aluminum oxides can also be readily deposited on current collector substrates. In addition, the thin film-on-substrate anode design provides increased Coulombic efficiency and charging rates compared to lithium plating on copper substrate alone, and provides higher gravimetric and volumetric energy than alloy cathodes alone. Furthermore, the electrochemically reactive metal storage capacity of the anode can be controlled by film thickness and elemental content (i.e., different metals have different alloying properties with the electrochemically reactive metal of the cathode; and different metal oxides have different reactivities with the cathode metals), as well as film morphology.

The following non-limiting embodiments are provided to describe certain aspects and features of the electrochemical reactors and methods described herein.

Embodiment 1 is a rechargeable electrochemical cell comprising, in a fully discharged state: a cathode and a layered anode with an electrolyte contacting the anode and the cathode; wherein the cathode comprises an electrochemically reactive first metal selected from the group consisting of Li, Na, Mg, and Zn; the layered anode comprises an electrically conductive substrate and a reactive film on the surface of the substrate; the reactive film comprises (a) an elemental metal different from the electrochemically reactive first metal of the cathode, or an elemental semimetal (e.g., B, Mg, Al, Ca, Zn, Ga, Ge, As, Sr, Rh, Pd, Ag, Cd, In, Sn, Sb, Te, Ba, Ir, Pt, Au, Hg, TI, Pb, and Bi) which is capable of reversibly alloying with, or forming a mixed phase with, the first metal of the cathode, or (b) a metal oxide or semimetal oxide (e.g., an oxide of at least one element selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi) that is capable of reversibly reacting with the first metal of the cathode; and the electrolyte comprises an electrolyte salt of the same metal as the reactive metal of the cathode; wherein the reactive film alloys with, forms a mixed phase with, or reacts with, the first metal from the cathode during charging of the cell, and releases the first metal back to the cathode during discharging of the cell to reconstitute the reactive film; and the reactive film has a thickness of about 1 to 100 nm.

Embodiment 2 is the electrochemical cell of embodiment 1, wherein the cathode optionally comprises lithium and the reactive film comprises at least one elemental metal selected from the group consisting of Mg, Al, Ga, Sn, In, Ag, Au, Pt, Zn, Pb, and Bi.

Embodiment 3 is the electrochemical cell of embodiment 1, wherein the cathode optionally comprises metallic lithium and the film comprises an oxide of at least one element selected from the group consisting of B, Ti, Zr, Nb, Zn, Al, Ga, In, and Sn; and the oxide optionally also comprises lithium ions.

Embodiment 4 is the electrochemical cell of any one of embodiments 1 to 3, wherein the reactive film of the anode has a three-dimensional, non-planar morphology.

Embodiment 5 is a rechargeable lithium electrochemical cell comprising, in a fully discharged state: a cathode comprising lithium and a layered anode with a lithium electrolyte therebetween; wherein the layered anode comprises an electrically conductive substrate and a film on a surface of the substrate in contact with the electrolyte; wherein the film comprises an elemental metal or semimetal selected from the group consisting of B, Mg, Al, Ca, Zn, Ga, Ge, As, Sr, Rh, Pd, Ag, Cd, In, Sn, Sb, Te, Ba, Ir, Pt, Au, Hg, TI, Pb, and Bi; the film having a thickness of about 1 nm to about 100 nm; wherein the film alloys with, or forms a mixed phase with, lithium from the cathode during charging of the cell, and releases the lithium back to the cathode during discharging of the cell to reconstitute the film.

Embodiment 6 is the electrochemical cell of embodiment 5, wherein the substrate of the anode is a copper foil or copper mesh.

Embodiment 7 is the electrochemical cell of embodiment 5 or 6, wherein the film comprises at least one metal selected from the group consisting of Mg, Al, Ga, Sn, In, Ag, Au, Pt, Zn, Pb, and Bi.

Embodiment 8 is the electrochemical cell of any one of embodiments 5 to 7, wherein the film comprises at least one metal selected from the group consisting of Al, Au, and Pt.

Embodiment 9 is the electrochemical cell of any one of embodiments 5 to 8, wherein the metal film additionally comprises at least some lithium.

Embodiment 10 is the electrochemical cell of any one of embodiments 5 to 9, wherein the lithium electrolyte is a liquid electrolyte comprising a lithium electrolyte salt in a non-aqueous aprotic solvent; the electrochemical cell further comprises a porous separator between the cathode and the anode; and the separator is immersed in, and permeable to, the liquid electrolyte.

Embodiment 11 is the electrochemical cell of any one of embodiments 5 to 9, wherein the lithium electrolyte is a polymer electrolyte comprising a lithium electrolyte salt dispersed in a polymer matrix (e.g., a solid polymer electrolyte, a composite polymer electrolyte, or a gel polymer electrolyte).

Embodiment 12 is the electrochemical cell of embodiment 11, wherein the polymer electrolyte further comprises a non-aqueous aprotic solvent dispersed in the polymer matrix.

Embodiment 13 is the electrochemical cell of any one of embodiments 5 to 12, wherein the film of the anode has a three-dimensional, non-planar morphology.

Embodiment 14 is a rechargeable lithium electrochemical cell comprising, in a fully discharged state: a cathode comprising lithium and a layered anode with a lithium electrolyte therebetween; wherein the layered anode comprises an electrically conductive substrate and a lithium-reactive metal oxide or semimetal oxide film having a thickness of about 1 nm to about 100 nm on a surface of the substrate in contact with the electrolyte; wherein the metal oxide or semimetal oxide is an oxide of at least one element selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi; the film reacts with lithium from the cathode during charging of the cell, and releases the lithium back to the cathode to reconstitute the metal oxide film during discharging of the cell.

Embodiment 15 is the electrochemical cell of embodiment 14, wherein the substrate of the anode is a copper foil or mesh.

Embodiment 16 is the electrochemical cell of embodiment 14 or 15, wherein the lithium-reactive metal oxide is an oxide of at least one element selected from the group consisting of B, Ti, Zr, Nb, Zn, Al, Ga, In, and Sn.

Embodiment 17 is the electrochemical cell of any one of embodiments 14 to 16, wherein the metal oxide or semimetal oxide also comprises lithium ions.

Embodiment 18 is the electrochemical cell of embodiment 17, wherein the metal oxide is a lithium aluminum oxide.

Embodiment 19 is the electrochemical cell of any one of embodiments 14 to 18, wherein the lithium electrolyte is a liquid electrolyte comprising a lithium electrolyte salt in a non-aqueous aprotic solvent; the electrochemical cell further comprises a porous separator between the cathode and the anode; and the separator is immersed in, and permeable to, the liquid electrolyte.

Embodiment 20 is the electrochemical cell of any one of embodiments 14 to 18, wherein the lithium electrolyte is a polymer electrolyte (e.g., a solid polymer electrolyte, a composite polymer electrolyte, or a gel polymer electrolyte) comprising a lithium electrolyte salt dispersed in a polymer matrix.

Embodiment 21 is the electrochemical cell of embodiment 20, wherein the polymer electrolyte further comprises a non-aqueous aprotic solvent dispersed in the polymer matrix.

Embodiment 22 is the electrochemical cell of any one of embodiments 14 to 21, wherein the film of the anode has a three-dimensional, non-planar morphology.

### BRIEF DESCRIPTION OF THE DRAWINGS

FIG. 1 schematically illustrates a rechargeable electrochemical cell as described herein.

FIG. 2 schematically illustrates charging of a lithium electrochemical cell with a lithiophilic film or coating of a lithium-alloying metal, M, on a copper substrate as the anode, in comparison to a conventional lithium electrochemical cell with just copper as the anode.

FIG. 3 schematically illustrates charging of a lithium electrochemical cell with a lithiophilic film or coating of a lithium-reactive metal oxide on a copper substrate as the anode.

FIG. 4 provides theoretical gravimetric capacities of metal thin film electrodes for thin films of Al, Zn, Ag, Au, and Pt at film thicknesses of 0.01 to 20 μm.

FIG. 5 provides plots of theoretical gravimetric capacity for aluminum films with film thicknesses of 0.01 to 20 μm at full charge capacities of 1, 2, 3, 4, and 5 mAh/cm².

FIG. 6, shows (A) plots of voltage versus capacity for the bare copper anode liquid electrolyte full cells at cycles 1 and 10; and (B) plots of voltage versus capacity for the Au-on-Cu anode liquid electrolyte full cells at cycles 1 and 10.

FIG. 7 shows plots of discharge capacity versus cycle for liquid electrolyte full cells with bare copper anode and Au-on-Cu anodes over 100 cycles.

FIG. 8 shows plots of voltage gap (left vertical axis) and resistance (Ohm cm²; right vertical axis) versus cycle for the bare copper anode liquid electrolyte full cells compared to the Au-on-Cu anode cells.

FIG. 9 shows plots of voltage versus capacity for polymer electrolyte half cells with (A) bare copper anode; (B) Au-on-Cu anode; and (C) Pt-on-Cu anode.

FIG. 10 shows (A) quantified nucleation and growth overpotentials for lithium plating for polymer electrolyte half cells with bare copper anode, Au-on-Cu anode, and Pt-on-Cu anode; and (B) Coulombic efficiency for the polymer electrolyte half cells.

FIG. 11 shows plots of voltage versus cycling efficiency for the Al-on-Cu polymer electrolyte half cells at 10, 20, 30 and 40 μA/cm² obtained (A) experimentally; compared to (B) computational results from modeling.

FIG. 12 shows plots of voltage versus capacity for liquid electrolyte cells at cycles 1 and 10 for cells with: (A) bare copper anode; (B) Li_{0.5}AlOₓ-on-Cu anode; (C) Li₁AlOₓ-on-Cu anode; and (D) Li₂AlOₓ-on-Cu anode.

FIG. 13 shows plots of discharge capacity versus cycle for liquid electrolyte full cells with bare copper anode and Li_{y}AlOₓ-on-Cu anodes over 100 cycles.

FIG. 14 shows plots of voltage gap (left vertical axis) and resistance (Ohm cm²; right vertical axis) versus cycle for liquid electrolyte full cells with bare copper anode compared to the Li_{y}AlOₓ-on-Cu anodes.

FIG. 15 shows plots of voltage versus capacity for polymer electrolyte half cells with (A) bare copper anode; (B) Li_{0.5}AlOₓ-on-Cu anode; (C) Li₁AlOₓ-on-Cu anode; and (D) Li₂AlOₓ-on-Cu anode.

FIG. 16 shows (A) plots of current density versus potential for polymer electrolyte half cells with bare copper anode versus Li_{y}AlOₓ-on-Cu anodes; (B) quantified nucleation and growth overpotentials for lithium plating for polymer electrolyte half cells with bare copper anode versus Li_{y}AlOₓ-on-Cu anodes; (C) critical current density for polymer electrolyte half cells with bare copper anode versus Li_{y}AlOₓ-on-Cu anodes; and (D) Coulombic efficiency for polymer electrolyte half cells with bare copper anode versus Li_{y}AlOₓ-on-Cu anodes.

FIG. 17 provides (A) cyclic voltammetry plots, (B) nucleation overpotential graphs, (C) growth overpotential graphs for 2.8 nm Al₂O₃-on-Cu anode and 2.1 nm ZnO-on-Cu anode anodes in polymer electrolyte half cells at 10 and 20 μA/cm², compared to bare copper anode; (D) plots of pre-plating charge loss and Li inventory loss versus film layer thickness (5, 10, and 20 nm) for solid polymer electrolyte cells comprising anodes with thin films of Al₂O₃ and ZnO on copper compared to bare copper anode; (E) plots of nucleation overpotential versus film layer thickness (5, 10, and 20 nm) for solid polymer electrolyte cells comprising anodes with thin films of Al₂O₃ and ZnO on copper compared to bare copper anode; and (F) plots of growth overpotential versus film layer thickness (5, 10, and 20 nm) for solid polymer electrolyte cells comprising anodes with thin films of Al₂O₃ and ZnO on copper compared to bare copper anode.

FIG. 18 shows (A) plots of voltage versus capacity for liquid electrolyte full cells having an anode comprising a thin film of Li₁AlOₓ or Li_{0.5}AlOₓ on a copper current collector at 2.09 mg/cm² cathode loading of LiFePO₄, compared to a bare copper anode at equivalent cathode loading; (B) graphs of formation charge for the Li₁AlOₓ and Li_{0.5}AlOₓ anode cells compared to bare copper anode at equivalent cathode loading; and (C) graphs of SEI (solid electrolyte interphase) resistance for the Li₁AlOₓ and Li_{0.5}AlOₓ anode cells compared to bare copper anode at equivalent cathode loading.

FIG. 19 shows plots of voltage versus capacity for liquid electrolyte full cells at 2.09 mg/cm² cathode loading of LiFePO₄ having (A) a bare copper anode; (B) a Li_{0.5}AlOₓ thin film on copper anode; and (C) a Li₁AlOₓ thin film on copper anode.

FIG. 20 shows (A) plots of discharge capacity versus cycle number for the cells of FIG. 19; and (B) plots of Coulombic efficiency versus cycle number for the cells of FIG. 19.

### DETAILED DESCRIPTION OF THE PRESENT INVENTION

A discharged electrochemical cell as described herein comprises an electrochemically reactive metal-containing cathode (e.g., a cathode comprising metallic Li, Na, Mg, or Zn; preferably metallic Li) and a layered anode with an electrolyte therebetween. The layered anode comprises an electrically conductive substrate (e.g., a metal foil or mesh, such as copper foil or copper mesh) and a reactive thin film comprising a metal, a semimetal, a metal oxide, or a semimetal oxide on the surface of the substrate. The reactive film is capable of reversibly alloying with, reversibly forming a mixed phase with, or reversibly reacting with the electrochemically reactive metal from cathode during charging of the cell, and releasing the electrochemically reactive metal back to the cathode during discharge of the cell. Preferably, the reactive film has a thickness of about 1 nm to about 100 nm. In some embodiments, the reactive film has a three-dimensional, nonplanar morphology, which can be achieved by a number of known processes.

In a particularly preferred embodiment, the electrochemical cell has a cathode comprising lithium and a lithium electrolyte; and the reactive film of the anode comprises either (a) a metal or semimetal capable of reversibly alloying with, or forming a mixed phase with, lithium during charging of the cell, or (b) a metal oxide or semimetal oxide film capable of reversibly reacting with or forming a mixed phase with lithium during charging of the cell. During discharge of the cell, the lithium from the reactive film returns to the cathode and the reactive film is reconstituted.

The novel anode design described herein utilizes very thin reactive films to utilize Li and other reactive metals such as Na, Mg, and Zn in the cathode, while suppressing dendrite formation and mechanical failure. Adding 3D morphology to the deposited anode thin films improves mechanical and electrochemical properties of the cell. For example, adding pores to create a “mesh” structure increases Coulombic efficiency drastically. In the case of a flat aluminum thin film versus an aluminum mesh thin film in a lithium cell, Coulombic efficiency increases from about 76% for the flat film to about 96% for a mesh, and providing a charging rate of at least 0.25 mA/cm², and a capacity of at least 1 mAh/cm² for Al—Li alloy mesh.

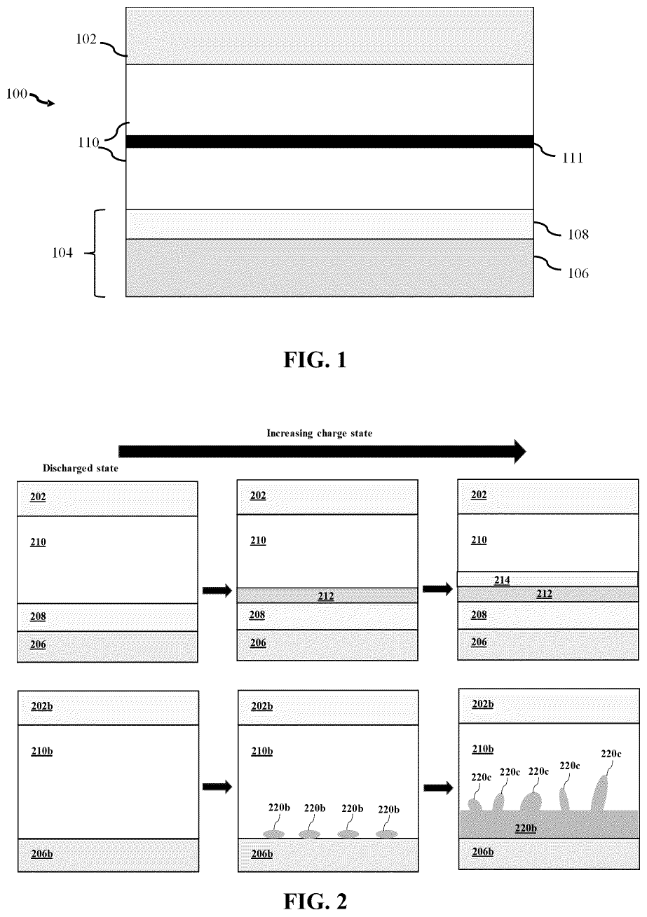

FIG. 1 schematically illustrates a discharged electrochemical cell comprising an electrochemically reactive metal (e.g., Li, Na, Mg, or Zn; preferably Li) cathode and a layered anode with an electrolyte therebetween. For purposes of convenience, FIG. 1 will be described for an electrochemical cell with a lithium cathode. In FIG. 1, discharged electrochemical cell 100 comprises lithium cathode 102 and layered anode 104 with electrolyte 110 therebetween. Layered anode 104 comprises a electrically conductive substrate 106 (e.g., copper foil) with a lithiophilic film 108 on a surface thereof, wherein the film 108 is capable of reversibly alloying or reversibly reacting with lithium from cathode 102 during charging of cell 100.

In some embodiments of the cell of FIG. 1, the lithiophilic film 108 comprises a lithium alloying metal or semimetal, M, e.g., a metal or semimetal selected from the group consisting of B, Mg, Al, Ca, Zn, Ga, Ge, As, Sr, Rh, Pd, Ag, Cd, In, Sn, Sb, Te, Ba, Ir, Pt, Au, Hg, TI, Pb, and Bi. The lithium alloying metal or semimetal is capable of alloying with, or forming a mixed phase with, lithium from cathode 102 during charging of cell 100. During discharge of cell 100, lithium is released from the alloy or mixed phase and returns to cathode 102.

In some other embodiments, the lithiophilic film 108 comprises a metal oxide or semimetal oxide, M′Oₓ (Formula I), wherein M′ comprises one or more metal or semimetal cations, e.g., one or more cations of a metal or semimetal selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi; and x is a positive number sufficient for oxygen anions in Formula I to balance the positive charge of the M′ cations. The metal oxide of Formula I is capable of reacting with lithium from cathode 102 during charging either to form a lithium metal oxide of formula Li_{y}M′Oₓ (Formula II), or to reduce the metal or semimetal oxide to the corresponding metal or semimetal. In Formula II, M′ is a defined in Formula I, y>0, and x is a positive number sufficient for the oxygen anions in Formula II to balance the positive charge of the Li and M′ cations. For example, M′ can be a single metal ion (e.g., Zn²⁺, in which case x is 1 and the metal oxide is ZnO) or can be two or more metal ions (e.g., two Al³⁺ ions, in which case x is 3 and the metal oxide is Al₂O₃).

Film 108 preferably has a thickness of about 1 nm to about 100 nm (e.g., about 1 to 50 nm, or about 1 to 20 nm). Lithium cathode 102 preferably has a thickness of about 0.1 μm to about 250 μm (e.g., 0.1 μm to about 10 μm, or about 50 μm to about 250 μm). In some embodiments, electrode substrate 106 is a foil or mesh of a metal such as a copper, nickel, carbon, titanium, iron, or steel.

Electrolyte 110 can be a polymer electrolyte (e.g., a solid polymer electrolyte, composite polymer electrolyte, or polymer gel electrolyte); a non-aqueous liquid electrolyte comprising lithium ions; or an inorganic solid electrolyte such as a lithium lanthanum zirconium oxide (LLZO) and similar materials. Optional separator membrane 111 is positioned between cathode 102 and anode 104 when electrolyte 110 is a liquid electrolyte to prevent direct contact of cathode 102 with anode 104, but is omitted when electrolyte 110 is a polymer electrolyte.

In embodiments in which the cathodes contain Na, Mg, or Zn, the electrolyte will comprise sodium, magnesium, or zinc cations, respectively, and the thin film will comprise a metal that can reversibly alloy with Na, Mg, or Zn, respectively, or the thin film will comprises a metal oxide that will reversibly react with Na, Mg, or Zn, respectively, as will be understood by one of ordinary skill in the battery arts based on the disclosure herein.

### Thin Film Metal-On-Substrate Anodes.

FIG. 2 schematically illustrates charging of a lithium electrochemical cell with a lithiophilic film or coating of a lithium-alloying metal, M, on copper as the anode in comparison to a conventional lithium electrochemical cell with just copper as the anode. FIG. 2, Panel A, provides an illustration of changes that occur during charging of an embodiment of a lithium cell disclosed herein works, and Panel B illustrates changes that occur during charging of a conventional “anode-free” lithium cell. FIG. 2, Panel A, shows an electrochemical cell as illustrated in FIG. 1, which in its fully discharged state (left) comprises lithium cathode 202 and a layered anode comprising a metal foil substrate 206 (e.g., copper foil) with a lithiophilic metal film 208 on a surface thereof. Electrolyte 210 is positioned between film 208 and cathode 202, and contacts both the anode and the cathode. Lithiophilic film 208 comprises a lithium-alloying metal, M. As charging begins (middle), a layer 212 of a lithium alloy of M (LiₙM, wherein n is a positive number less than 20) forms on film 208 by electrochemical-induced transport of lithium to the film 208 from cathode 202. As charging of the cell progresses further (right), a homogeneous layer 214 of a lithium metal, possibly containing a small amount of M (e.g., MLiₘ, wherein m is a number greater than 1), forms on layer 212. Upon discharge of the charged (or partially charged) cell, lithium from layers 214 migrates back to cathode 202. Depending on the amount of discharge, lithium from layer 212 can also migrate back to cathode 202, and M from layers 214 and 212 returns to lithiophilic metal film 208. In solid state battery configurations, electrolyte layer 210 can be a solid state polymer or ceramic material. In liquid electrolyte battery configurations, a separator membrane will be positioned between the anode and cathode to prevent direct contact of the anode and cathode, which would lead to a short.

In contrast, as shown in FIG. 2, Panel B, in its fully discharged state (left) the conventional lithium cell comprises lithium cathode 202b and metal foil anode 206b with a with electrolyte 210b positioned between and contacting metal foil anode 206b and cathode 202b. As charging begins (middle), discrete patches of lithium metal 220b form on anode 206 by electrochemical-induced transport of lithium to anode 206 from cathode 202. As charging of the cell progresses further (right), a non-uniform layer of lithium metal 220b forms on anode 206b, which includes dendrites 222b protruding from the surface toward cathode 202b. As is well known in the battery arts, dendrite formation is an undesirable process, which can lead, e.g., to reduced battery lifetime, and shorting of the cell. The unique and innovative cell design described herein suppresses dendrite formation.

The thickness (e.g., 1 nm to 100 nm) and elemental composition (e.g., choice of alloying metals and semimetals such as B, Mg, Al, Ca, Zn, Ga, Ge, As, Sr, Rh, Pd, Ag, Cd, In, Sn, Sb, Te, Ba, Ir, Pt, Au, Hg, Tl, Pb, and Bi) of the thin metal or semimetal films described herein control the amount of charge that can be achieved before onset of metal plating of the cathode metal on the anode, and metal dendrite formation. For example, a 50 nm film of Al can hold about 0.013 mAh/cm² equivalents of Li metal, while a 2 μm film of Al can hold about 0.53 mAh/cm² equivalents of Li metal before Li plating occurs.

In addition, different alloying metals can accept different amounts of metals such as lithium before onset of metal plating, which will be dependent on factors such as nucleation and growth overpotential, morphology of the film, critical current density, and Coulombic efficiency. Table 1 provides lithium:metal (M) ratios and lithiated film charge values for M=Zn, Al, In, Au, Pt, and Ag, along with the lithiated film charge, based on a 50 nm uniform film of M.

TABLE 1

| Metal | Highest Li:M | Lithiated Film Charge for 50 nm of M | |
|---|---|---|---|
| Zn | 1:1 | 15 | μAh/cm² |
| Al | 1:1 (9:4) | 13-40 | μAh/cm² |
| In | 3:1 | 26 | μAh/cm² |
| Au | 3:1 | 39 | μAh/cm² |
| Pt | 5:1 | 74 | μAh/cm² |
| Ag | 7:1 (20:1) | 91-260 | μAh/cm² |

As described herein, lithium cells with anodes comprising lithiophilic layers of Al, Pt and Au on a copper substrate have demonstrated 80 to 96% Coulombic efficiency with polymer electrolytes and a lithium cathode, compared to 80 to 90% with copper alone. Importantly, the critical current density and total capacity before dendrites form is increased by 50% for the thin film metal on copper anodes described herein compared to lithium plating on copper alone. Providing lithium-alloying metal layers with three-dimensional (3D) morphology can also enhance Coulombic efficiency, critical current density, and other performance attributes. Such 3D morphology can be obtained, for example, by depositing the metal coating onto a metal substrate (e.g., a metal foils such as copper foil) with an embossed surface pattern; depositing the metal coating on a metal mesh (e.g., a copper mesh); depositing the metal layer at least partially within pores of a porous metal substrate (e.g., a porous copper substrate, or a copper substrate with a porous or pitted surface); and the like.

The metal-lithium alloying anode design described herein allows uniform plating of lithium metal alloys on a lithiophilic substrate with high lithium ion/atom diffusion to prevent dendrite formation while maintaining the high energy density of lithium metal. This design increases the effective charging rate and efficiency in solid-state lithium metal batteries, as well as liquid electrolyte cells, and is also applicable to Na, Mg, and Zn cells with appropriate adjustment of the electrolyte.

### Deposition of Thin Metal and Semimetal Layers

Thin uniform films of metals and semimetals can be deposited on the anode substrate by a number of well-known processes, including physical vapor deposition such as sputtering, evaporation, and atomic layer deposition (ALD); electroplating; and galvanic replacement. The deposited metal or semimetal layer can comprise a single element or combination of elements. Metal oxides, sulfides, and nitrides can also be deposited as “precursor” layers for generation of the metal film. In addition, the deposited film can comprise a pure metal/semimetal or mixture of metals/semimetals, or can be deposited as an alloy with the electrochemically reactive metal of the cathode to create an already charged or partially charged anode. Several suitable techniques for thin film deposition are described below:

### Sputtering:

The substrate electrode foil is fixed on a rotating stage. In a high-vacuum chamber, DC sputtering is used to deposit the target metal or semimetal atoms onto the substrate surface. The deposition takes place in line-of-sight fashion, so flat substrates are ideal. The deposition rate is about 0.1 nm/s, so a 50 nm film would take under 10 minutes to deposit. The film roughness is <1 nm. Co-deposition of more than one metal at a time is possible. This method is useful for depositing a wider range of metals and metal-containing species. Example: Sputtering aluminum onto copper.

### Evaporation (Thermal and E-Beam):

The substrate electrode foil is fixed on stage. In a high-vacuum chamber, a target metal or semimetal is heated by either a hot heating element or a continuous beam of electrons. This causes the metal atoms to vaporize and deposit in line-of-sight fashion onto the surface, so flat substrates are ideal. The deposition rate is about 0.1 nm/s, so a 50 nm film would take under 10 minutes to deposit. The film roughness is <1 nm. This method is useful for depositing metals with higher vapor pressures at elevated temperatures (e.g., Au, Li). Example: Evaporating gold onto copper.

### Atomic Layer Deposition:

The substrate electrode is fixed in a heated chamber. A metal or semimetal precursor gas is flowed into the chamber, depositing a single layer of metal or semimetal ions on the surface. Then, a secondary gas is flowed into the chamber to react with the metal/semimetal species, leaving only metal/semimetal atoms remaining and removing the gaseous products. This two-step cycle is repeated to achieve the desired thickness. This allows precise control of the metal or semimetal amount and pinhole-free deposition at thicknesses below 10 nm. This process is useful for depositing the metal, semimetal, metal oxide, semimetal oxides, or other species on a variety of surface, including, e.g., conformally in a porous substrate. Many elements and multi-atomic species can be deposited in this way, although precursors can be expensive. Example: Depositing silver onto copper, depositing aluminum oxide onto copper.

### Electrodeposition:

A substrate electrode is fixed in a flooded electrochemical cell as the working electrode. The metal to be deposited is used in salt form in the electrolyte. A counter electrode can be any material, either the deposited metal/semimetal or some agnostic material that performs an anodic reaction (e.g., water splitting to evolve oxygen). A negative current is applied to the working electrode, which reduce metal ions from solution onto the surface to form a metal or semimetal film. The thickness, roughness, nucleation density, and porosity are controllable with the applied current, time, convection, and temperature. This allows co-deposition of multiple metals or semimetals. This is useful for depositing the metal/semimetal conformally in a porous substrate. The electrode polarity can also be reversed, such that species on the surface are oxidized to form metal oxides or semimetal oxides. Example: Electrodepositing zinc onto copper, electrodeposition of manganese oxide onto titanium.

### Galvanic Exchange:

A substrate electrode is submerged in a solution with a salt of the metal or semimetal to be deposited. Since the substrate metal has a lower reduction potential than the metal/semimetal ion in solution, it will spontaneously give electrons to those ions, resulting in replacement of the surface metal. The thickness, roughness, and porosity are controllable with the salt concentration, time, convection, and temperature. This method requires no direct energy input. This is useful for depositing the metal or semimetal conformally in a porous substrate. Example: Replacing copper with silver.

### Charging the Battery

When charging the battery, lithium atoms alloy with the lithiophilic metal film to make different LiₙM phases. When these phases reach their maximum lithium content, lithium metal will plate on the film. Depending on the metal chemistry and electrode structure, lithium may plate above, below, or mixed with the alloy phase.

### Discharging the Battery

When discharging, lithium metal will strip from the anode first until depleted. The alloy phase can then be delithiated to totally recover all charge or be left intact as a lithiophilic substrate for the next charging cycle.

### Microstructure and Morphology

The metal or semimetal film deposition and charge/discharge strategy described herein is viable for electrodes with porous or 3D structures, which can be prepared by using a substrate electrode (e.g., copper) that has a three-dimensional pattern or a porous morphology on its surface such that the metal or semimetal film takes on a pattern or at least partially deposits in the pores.

### Depositing 3D Metal or Semimetal Structures

In order to prepare a 3D structured film, a structure template is prepared on the substrate of the electrode. Such structure templates can be formed by photolithography (widely used in semiconductor industry), e.g., by self-assembled polymer structures, metal/metal oxide deposition; electroplating around the insulating template then removal to leave the metal or semimetal film. 3D structures can also be prepared by atomic layer deposition around or in the assembled structure.

### Key Features and Benefits

Thin films of metals or semimetals can be deposited onto current collectors with whatever microstructure is desired by well-known deposition methods. Low-cost, low-weight metals such as Al and Zn, or ultra-low amounts of high-performance metals such as Ag can be used, depending on cost a performance features required for a given application or use. In addition, the thin metal film-on-substrate anode design provides increased Coulombic efficiency and charging rates compared to lithium plating on copper substrate alone, and provides higher gravimetric and volumetric energy than alloys alone. Furthermore, the storage capacity of the anode (e.g., storage capacity for Li, Na, Mg, or Zn) can be controlled by film thickness and elemental content (different metals have different alloying properties with cathode metals such as lithium).

### Broader Applications

The thin film-on-metal substrate anode design described herein can be applied to other metal batteries besides lithium, such as sodium, magnesium, and zinc batteries by use of metallic sodium, magnesium or zinc in the cathode in combination with an anode comprising a thin film of a metal or semimetal that can alloy with, or form a mixed phase with, the cathode metal, where the metal or semimetal of the anode film is selected for its affinity for the electrochemically reactive metal of the cathode. The electrodes can also be utilized in other applications, such as electrochemical ammonia synthesis, or to replace reactive lithium metal with high-surface area, reducing alloys for chemical synthesis.

### Thin Film Metal or Semimetal Oxide-On-Substrate Anodes.

In another aspect, the thin film-on-substrate anodes design can comprise a thin film of a metal oxide or semimetal oxide on the current collector substrate. The overall structure of the electrochemical cell is the same as is illustrated in FIG. 1, above, in which film 108 comprises a metal oxide or semimetal oxide capable of reversibly reacting with lithium or another electrochemically reactive cathode metal during charging and of releasing the electrochemically reactive metal during discharge of the cell. The metal or semimetal oxides preferably are oxides of metals or semimetals such as Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi. Optionally, for lithium cells, the metal/semimetal oxide thin films can be partially or fully lithiated to afford pre-charged anodes at selected levels of lithium charging, before assembly of the cell. The metal oxide is a material of formula M′Oₓ (Formula I, as defined above), wherein M′ comprises one or more metal cations, e.g., one or more cations of a metal or semimetal selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi; and x is a positive number sufficient for oxygen anions in Formula I to balance the positive charge of the M′ cations. The metal/semimetal oxide of Formula I is capable reacting with the electrochemically reactive metal of the cathode, e.g., lithium, during charging to form a mixed metal oxide, e.g., a mixed metal oxide of formula Li_{y}M′Oₓ (Formula II) in the case of a lithium cell, wherein M′ is a defined in Formula I, y>0, and x is a positive number sufficient for the oxygen anions in Formula II to balance the positive charge of the Li and M′ cations, or of being fully reduced to pure M′ or an M′-lithium alloy with simultaneous formation of lithia.

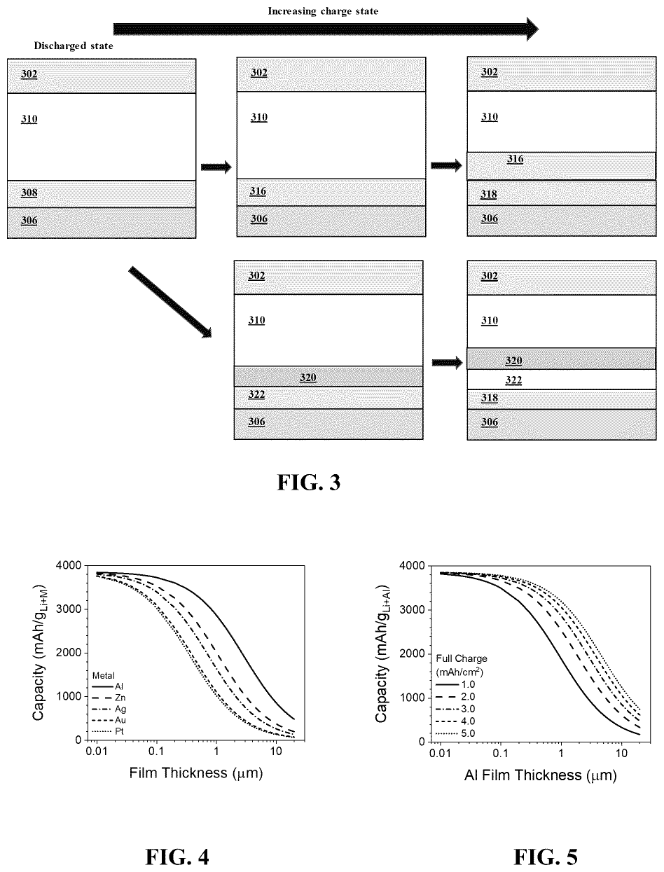

FIG. 3 schematically illustrates charging of a lithium electrochemical cell with a film of lithium-reactive metal oxide, M′Oₓ, on copper as the anode. FIG. 3 shows an electrochemical cell as illustrated in FIG. 1, which in its fully discharged state (top left) comprises lithium cathode 302 and a layered anode comprising a metal foil substrate 306 (e.g., copper foil) with a lithiophilic metal oxide film 308 on a surface thereof. Electrolyte 310 is positioned between film 308 and cathode 202, and contacts both the anode and the cathode. Lithiophilic metal oxide film 308 comprises a lithium-reactive metal oxide of Formula I. As charging progresses (middle), the metal oxide of Formula I can follow two different charging pathways, i.e., charging pathway A—lithium metal oxide formation (top middle and top right) or charging pathway B—reduction of the metal oxide (bottom middle and bottom right). In charging pathway A, lithiation of the metal oxide of Formula I converts film 308 into a film 316 of a lithium metal oxide of Formula II (top middle) by electrochemical-induced transport of lithium to the film 308 from cathode 302. As charging of the cell progresses further (top right), a layer of lithium metal 318 deposits below layer 316. Depending on the properties of layer 316, lithium 318 may also deposit above layer 316. Upon discharge of the charged (or partially charged) cell, lithium from layer 318 migrates back to cathode 302, and depending on the chemistry of the metal oxide, lithium from layer 316 migrates back to cathode 302 and the metal oxide of film 308 reconstitutes or layer 316 remains intact as a lithiated metal oxide. In charging pathway B, lithium from cathode 302 reduces metal oxide layer 308 to form a layer 322 comprising M′ or an M′-lithium alloy, and a layer of lithia (Li₂O) 320 on layer 322 (FIG. 3, bottom middle). Lithia layer 320 may also be dispersed within layer 322, depending on the thickness and chemistry of layer 308. As charging progresses a layer of lithium 318 deposits below layer 322. Depending on the properties of layer 322, lithium 318 may also deposit above layer 322. During discharge, lithium from layers 318 and 322 return to cathode 302, and depending on the depth of discharge, lithium from layer 320 may also return to cathode 302 and reconstitute metal oxide layer 308. In solid state battery configurations, electrolyte layer 310 can be a solid-state polymer material comprising a lithium salt. In liquid electrolyte battery configurations, a separator will be positioned between the anode and cathode to prevent direct contact of the anode and cathode, which would lead to a short.

### Deposition of Thin Metal Oxide Layers

Atomic layer deposition (ALD) from metal precursors and water can be used to prepare metal oxide thin films in thicknesses of about 1 to about 10 nm. Either pure metal oxides or pre-lithiated metal oxides can be prepared via ALD or by secondary Li deposition onto the metal oxide. In ALD, the substrate electrode is fixed in a heated chamber. A metal precursor gas is flowed into the chamber, depositing a single layer of metal ions on the surface. Then, a secondary gas containing oxygen (usually water) if flowed into the chamber to react with the metal species, leaving M′Oₓ and removing the gaseous products. This two-step cycle is repeated to achieve the desired thickness. This allows precise control of the metal amount and pinhole-free deposition at thicknesses below 10 nm. This is useful for depositing the metal conformally in a porous substrate. Many elements can be deposited in this way, although precursors can be expensive.

The ALD process can be modified to make lithiated metal oxides (Li_{y}M′Oₓ) by replacing the metal precursor with lithium tert-butoxide in every other M′Oₓ deposition step. This deposits LiOH, which is then reacted by the next M′Oₓ sequence to leave LiM′Oₓ. The amount of lithiation per other metal atom is controllable by varying the number of LiOH cycles to M′Oₓ cycles. Lithium to metal ratios of Li:M>1 are possible for very thin films (<5 nm), while Li:M′≤0.55 is possible for any thickness. Example: Depositing Li_{0.5}AlOₓ onto copper.

### In Situ Lithiation and or Conversion

When charging the battery, the metal oxide coating is reduced to either a lithium metal oxide (pathway A described above), which comprises lithiation of the metal oxide coating layer, where the metals are partially reduced and lithium ions exist in the metal oxide framework; or following pathway B described above, conversion of the metal oxide layer, where the metals are completely reduced to pure metals or lithium alloys and the oxide is converted to lithium oxide.

### Discharging the Battery

When discharging, the lithium metal deposited on the metal foil substrate will strip first until depleted. If present, the alloy phase may then be delithiated to totally recover all charge or may be left intact as a lithiophilic substrate for the next charging cycle.

### Microstructure and Morphology

This deposition and charge/discharge strategy is viable for electrodes with porous or 3D structure, as in the case of the thin metal film design.

### Chemistry and Thickness Determine Mechanisms

Less lithium-reactive metal oxides can lithiate to form an ionically conductive layer, while more lithium-reactive metal oxides can reduce completely to form pure metals and/or metals of lithium alloys and lithium oxide (lithia) layers. Pre-lithiation can be used to afford conductivity and Li excess in anode-free cell designs.

The less/more lithium-reactive character of the oxide stems from the metal in MOₓ.

Typically, relatively high valency metals near the top of the periodic table, like Al³⁺, are considered less lithium-reactive due to their high charge density and ability to hold onto ligands (in this case oxygen) much more strongly, making them more difficult to reduce and lithiate. In contrast, more lithium-reactive oxides would use metals with more delocalized charge, like Zn²⁺ or In³⁺, that have weaker metal-oxygen bonding and more ability to be reduced. This leads to differences in reactivity, where it is much harder to split the Al—O bond with lithium than it is to split the Zn—O bond, resulting in just lithiation of AlOₓ to Li_{y}AlOₓ versus full reduction and conversion of ZnOₓ to LiZn and Li_{y}Oₓ.

### Air and Lithium Stability

Pure oxides and ALD-lithiated oxides are stable to air and moisture, while lithiated oxides like LiAlO₂ and LiGaO₂ are stable against lithium metal for extended periods of time.

In embodiments of the rechargeable batteries described herein which comprise liquid electrolytes, the electrolyte comprises an electrolyte salt (e.g., an electrochemically stable lithium salt, sodium salt, magnesium salt or zinc salt, depending on the respective metal of the cathode) dissolved in a non-aqueous, aprotic solvent. In the case of lithium batteries, the electrolyte salt can be utilized in the electrolyte compositions for lithium electrochemical cells described herein, such as the salts described in Jow et al. (Eds.), Electrolytes for Lithium and Lithium-ion Batteries; Chapter 1, pp. 1-92; Springer; New York, NY (2014), which is incorporated herein by reference in its entirety.

Non-limiting examples of electrochemically active lithium salts include, e.g., lithium bis(trifluoromethanesulfonyl)imidate (LiTFSI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato)borate (LiB(C₂O₄)₂ or “LiBOB”), lithium difluoro(oxalato)borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl)imidate (LiFSI), lithium bis(pentafluoroethylsulfonyl)imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. In some embodiments, the lithium salt is present in the electrolyte at a concentration in the range of about 0.1 M to about 5 M, e.g., about 0.5 M to 2 M, or 1 M to 1.5 M. In the case of Na, Mg and Zn cells, the lithium is replaced by Na, Mg, or Zn, depending on the electrochemically reactive metal of the cathode.

The non-aqueous, aprotic solvent for the electrolyte compositions include the solvents described in Jow et al. (Eds.), Electrolytes for Lithium and Lithium-ion Batteries; Chapter 2, pp. 93-166; Springer; New York, NY (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds.

In some embodiments, the non-aqueous solvent for a rechargeable battery as described herein can be an ionic liquid. Any electrochemically stable ionic liquid solvent can be utilized in the electrolytes described herein, such as the solvents described in Jow et al. (Eds.), Electrolytes for Lithium and Lithium-ion Batteries; Chapter 4, pp. 209-226; Springer; New York, NY (2014), which is incorporated herein by reference in its entirety. The ionic liquid can optionally include a cation of the metal of the cathode, e.g., a lithium cation, a sodium cation, a magnesium cation, or a zinc cation, which can act directly as the electrolyte salt.

The electrolyte compositions for lithium batteries described herein also can optionally comprise an additive such as those described in Jow et al. (Eds.), Electrolytes for Lithium and Lithium-ion Batteries; Chapter 3, pp. 167-182; Springer; New York, NY (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about 0.25 M, or about 0.01 M to about 0.1 M. A commonly used electrolyte composition is 1.2 M LiPF₆ in 3/7 (wt/wt) EC/EMC.

Cathode active materials comprising the electrochemically reactive metal can be any cathode material commonly used in lithium, sodium, magnesium or zinc batteries, which are well known in the battery arts. Non-limiting examples of cathode materials for lithium batteries include, layered lithium metal oxide cathode materials such as LiMO₂ wherein M=Mn, Ni, Co or a combination thereof (e.g., a layered lithium nickel-manganese-cobalt oxide such as LiNi_{0.5}Mn_{0.3}CO_{0.2}O₂, referred to as NMC532; and similar materials); a spinel lithium metal oxide such as Li₂M′₂O₄ wherein M′=Mn, Ni, Co or a combination thereof; a structurally integrated layered-layered (LL) lithium metal oxide such as xLi₂MnO₃·(1-x)LiMn_{y}M_{1-y}O₂ wherein 0<x<1, 0≤y≤1, M=Ni, Co, or Ni and Co; a structurally integrated layered-spinel (LS) lithium metal oxide such as xLi₂MnO₃·(1-x)Li₂Mn_{y}M_{2-y}O₄ wherein 0<x<1, 0≤ y≤2, M=Ni, Co, or Ni and Co; a structurally integrated layered-layered-spinel (LLS) lithium metal oxide such as z[xLi₂MnO₃·Li₂Mn_{y}M_{2-y}O₄]·(1-z)Li₂M′₂O₄ wherein 0<x<1, 0≤ y≤1, 0<z<1, M=Ni, Co, or Ni and Co, and M′=Mn, Ni, Co or a combination thereof; a lithium metal phosphate such as LiFePO₄; or any other cathode active material used in lithium ion batteries. As used herein, a structurally-integrated composite metal oxide is a material that includes domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite metal oxides are different from and generally have different properties than mere mixtures of two or more metal oxide components (for example, mere mixtures do not share a common oxygen lattice).

Electrochemical cells and batteries with liquid electrolytes typically comprise a porous separator between the cathode and anode. The separator component of the lithium-ion cell can be any separator used in the lithium battery art. A typical material is a porous polyalkylene material such as microporous polypropylene, microporous polyethylene, a microporous propylene-ethylene copolymer, or a combination thereof, e.g., a separator with layers of different polyalkylenes; a poly(vinylidene-difluoride)-polyacrylonitrile graft copolymer microporous separator; and the like. Examples of suitable separators are described in Arora et al., Chem. Rev. 2004, 104, 4419-4462, which is incorporated herein by reference in its entirety. In addition, the separator can be an ion-selective ceramic membrane such as those described in Nestler et al., AIP Conference Proceedings 1597, 155 (2014), which is incorporated herein by reference in its entirety.

A battery can be formed by electrically connecting two or more such electrochemical cells in series, parallel, or a combination of series and parallel. For convenience, however, the term “battery” is often used by those of ordinary skill in the art to encompass both electrochemical cells and actual batteries (electrically connected electrochemical cells). In keeping with this common practice, the term “battery” and will be used interchangeably herein with the term “electrochemical cell”.

Electrochemical cells and battery designs and configurations, and electrolyte salts, solvents and other battery or electrode components (e.g., separator membranes, current collectors) are well known in the secondary battery art, e.g., as described in “Lithium Batteries Science and Technology” Gholam-Abbas Nazri and Gianfranco Pistoia, Eds., Springer Science+Business Media, LLC; New York, NY (2009), which is incorporated herein by reference in its entirety.

Solid-state electrolytes can be utilized in the batteries described herein without a separator, as the solid-state electrolyte, itself, affords a physical barrier to contact between the anode and the cathode. Solid state electrolytes useful in the rechargeable electrochemical cells and batteries described herein can be solid polymers or gel polymers. Solid polymer electrolytes typically comprise an electrolyte salt, as described above, dissolved or dispersed in a polymer matrix. Composite polymer electrolytes are solid polymer electrolytes containing a harder ceramic or glass inorganic phase from 0 to 80 wt % of the inorganic filler additive, which improves the mechanical properties and enhances ion transport. Typical inorganic fillers are Al₂O₃, TiO₂, SiO₂, undoped or doped Li₂La₃Zr₂O₁₂, undoped or doped LiₓLa_{y}TiO₃, undoped or doped LiₓAl_{y}TiPO₄, undoped or doped LiₓAl_{y}GePO₄, Li₃PS₄, Li₂P₃S₁₁, and undoped or doped Li₆PS₅Cl. A polymer gel electrolyte typically comprises a non-aqueous solvent and an electrolyte salt, both as described above, which together with a polymer form a gel composition. In typical solid polymer electrolytes, the polymer matrix often is an ether-based polymer such as poly(ethylene oxide), also known as PEO, or poly(propylene oxide), also known as PPO, because the polymers can be made in amorphous forms which can be can be fabricated into relatively thin, flexible films, and can support dissolved or dispersed electrolyte salts (see e.g., Helena Berg, Batteries of Electric Vehicles Materials and Electrochemistry, Cambridge University Press, pp. 123-124, which is incorporated herein by reference. Other polymers useful in solid polymer electrolytes include poly(acrylonitrile), also known as PAN, poly(methylmethacrylate), also known as PMMA, poly(vinylidene difluoride) also known as PVdF (id.). Fully inorganic solid state electrolytes can also be used, such as undoped or doped Li₂La₃Zr₂O₁₂ (LLZO), undoped or doped LiₓLa_{y}TiO₃ (LLTO), undoped or doped LiₓAl_{y}TiPO₄ (LLTO), undoped or doped LiₓAl_{y}GePO₄ (LATP), Li₃PS₄, Li₂P₃S₁₁, undoped or doped Li₆PS₅Cl, lithium phosphorus oxynitride (LiPON), and lithium metal halides (Li_{z}MX_{y}, where M is a metal and X is F, Cl, Br, or I).

The following non-limiting examples are provided to illustrate certain features and advantages of the electrochemical cells described herein.

### Example 1. Theoretical Capacities of Metal Thin Film Electrodes

Theoretical gravimetric capacities of metal thin film electrodes were calculated for thin films of Al, Zn, Ag, Au, and Pt at film thicknesses of 0.01 to 20 μm on a planar substrate deposited by any means. The results are shown in FIG. 4. The results in FIG. 4 demonstrate that film thickness controls anode gravimetric capacity. For example, to maintain 3000 mAh/gₜₒₜₐₗ of anode capacity, thin films should not exceed 800 nm for Al, 320 nm for Zn, and 100 nm for Pt. FIG. 5 provides plots of theoretical gravimetric capacity for aluminum films with film thicknesses of 0.01 to 20 μm at full charge capacities of 1, 2, 3, 4, and 5 mAh/cm². The results in FIG. 5 demonstrate that the capacity depends on the maximum amount of charge (benchmark is 3 mAh/cm²), and is independent of how much Li goes into the alloy phase, and more dependent on density of metal film. For example, or a 500 nm-thick Al film, the capacity will be limited to about 1900 mAh/gₜₒₜₐₗ if 0.5 mAh/cm² is charged, but 3300 mAh/gₜₒₜₐₗ if 3.0 mAh/cm² is charged.

Specific capacities were calculated based on the charge of lithium reduced at the electrode relative to the weight of that reduced lithium plus the weight of the thin film. Given the density of lithium (0.534 g/cm³), the density of the metal (e.g., Al=2.70 g/cm³), and the thicknesses of the films over an area of 1 cm², a weight was calculated. The specific capacity of pure Li metal is 3861 mAh/g.

For example, a 100 nm thin film of Al with a 1 mAh/cm² charge of lithium would weigh: (10⁻⁵ cm×2.70 g/cm³)+(1 mAh/cm^{2/3861} mAh/g)=27 μg/cm² Al+259 μg/cm² Li=286 μg/cm² total. With the charged areal capacity of 1 mAh/cm², the specific capacity would be 1 mAh/286 μg=3497 mAh/g_{Al+Li}.

FIG. 4 shows this for different metals, showing that the lower the density of the thin film metal, the higher specific capacity overall. FIG. 5 shows that the more lithium is charged compared to a set thin film thickness, the higher the specific capacity of anode overall.

### Example 2. Evaluation of Liquid Electrolyte Full Cells With Au-on-Cu Anodes

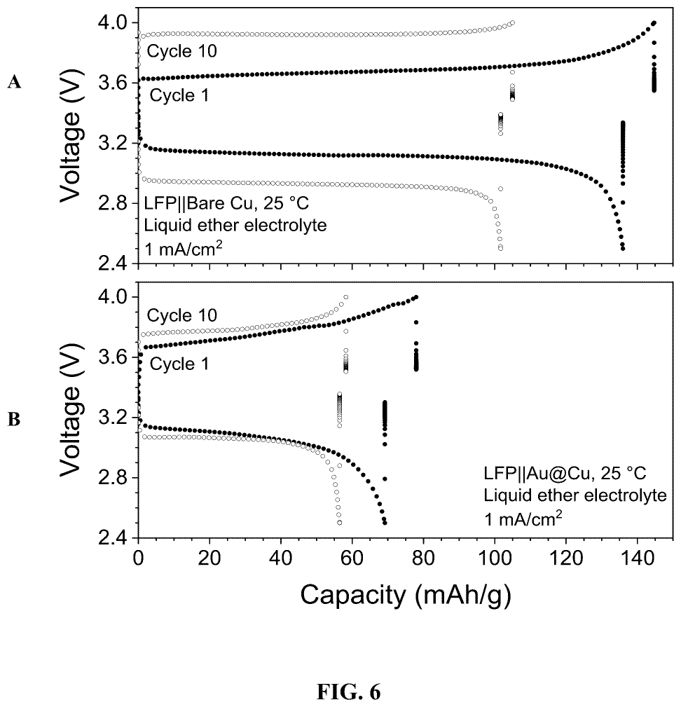

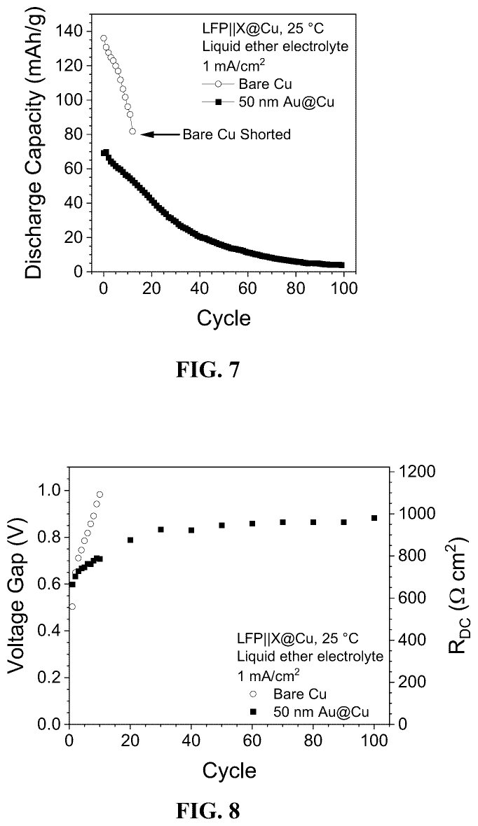

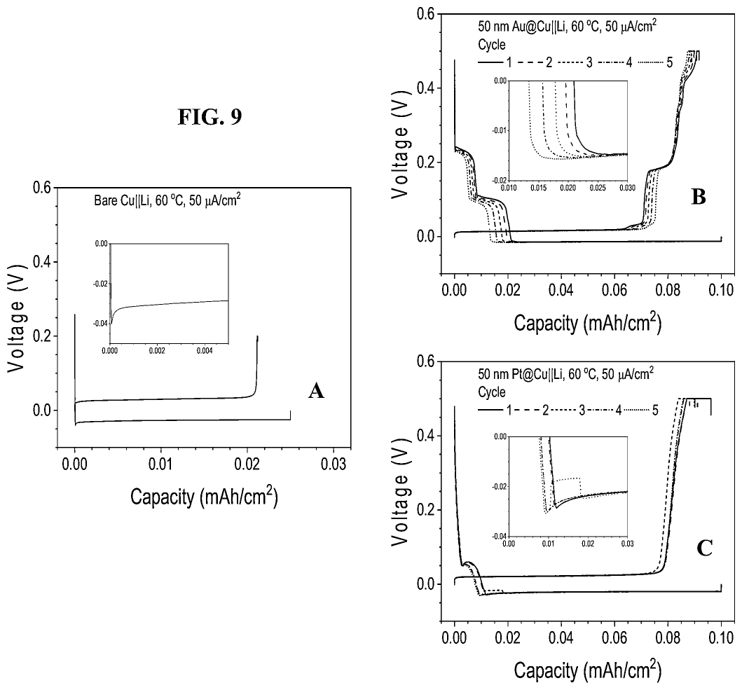

Electrochemical cells were prepared in 2032 coin cell format, with 1 cm² area electrodes, 12 mg/cm² cathode loading of LifePO₄, 45 μL of electrolyte (1 M LiFSI+1 M LiNO₃ in DME), a 50 nm gold thin film-on-copper foil (Au-on-Cu) anode (note: in this and the following figures, the notation X@Cu is used as a short hand for a thin film of a metal or metal oxide (X) on copper substrate), and a CELGARD separator. The cells were evaluated at room temperature (23-25° C.): each cell was subjected to a 5-hour formation cycle at 0.05 mA/cm² and then charge/discharge cycled at 1 mA/cm² for 100 cycles, and compared to similar cells in which the anode was bare copper foil. The results are shown in FIGS. 6, 7, and 8. FIG. 6, Panel A, shows plots of voltage versus capacity for the bare copper anode cells at cycles 1 and 10, and Panel B shows plots of voltage versus capacity for the Au-on-Cu anode cells at cycles 1 and 10. FIG. 7 shows plots of discharge capacity versus cycle for the bare copper and the Au-on-Cu cells over 100 cycles. FIG. 8 shows plots of voltage gap (left vertical axis) and cell areal resistance (Ohm cm²; right vertical axis) versus cycle for the bare copper anode cells compared to the Au-on-Cu anode cells. Voltage gap and areal resistance are related by Ohms law, i.e., potential is equal to current times resistance.

### Results and Implications.

As is evident in FIG. 7 and FIG. 8, the bare Cu anode-based cells short in 12 cycles, while Au-on-Cu anode cells do not short. Au-on-Cu is more reliable and safer at high charging rates. All cells show capacity decrease over time, but this is less pronounced in Au-on-Cu vs. Bare Cu, thus Au-on-Cu anodes will have longer battery lifetimes than bare Cu. FIG. 7 shows plots of discharge capacity versus cycle for the bare copper and the Au-on-Cu cells over 100 cycles. As is evident in FIG. 8, the voltage gap between charge and discharge steps increases drastically to >1 V on bare Cu, while the gap plateaus to <1 V with Au-on-Cu. The voltage efficiency of the battery (the energy needed to charge vs. the energy output of the battery) is at least 20% greater for Au-on-Cu than bare Cu since the cell resistance is lower overall.

### Example 3. Evaluation of Polymer Electrolyte Half Cells with Au-On-Cu and Pt-On-Cu Anodes

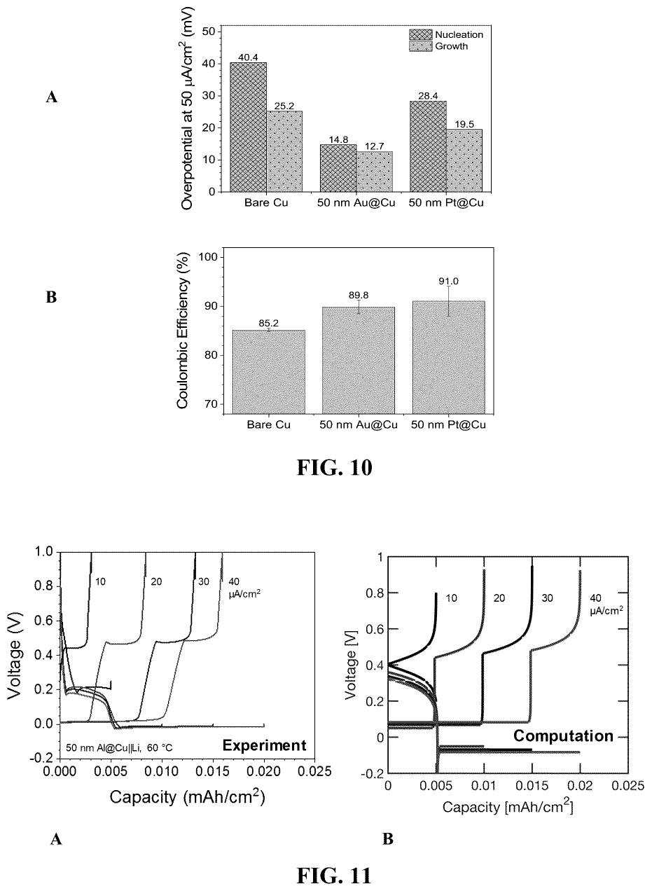

Polymer electrolyte half cells were prepared in 2032 coin cell format, with 1 cm² area electrodes, 250 μm lithium foil, 50 μm thick solid polymer electrolyte as electrolyte and separator (LiTFSI in PEO with a 15:1 EO:Li mol:mol ratio) with 50 nm Au-on-Cu and 50 nm Pt-on-Cu anodes. The cells were evaluated at 60° C.: each cell was subjected to SEI formation cycles and then at 20 and 50 μA/cm² for 10+ cycles, and compared to similar cells in which the anode was bare copper foil. The results are shown in FIG. 9 and FIG. 10. FIG. 9 shows plots of voltage versus capacity for polymer electrolyte half cells with (A) bare copper anode; (B) Au-on-Cu anode; and (C) Pt-on-Cu anode. The insets show the nucleation region of the Li plating curves. FIG. 10 shows (A) quantified nucleation and growth overpotentials for lithium plating for the polymer electrolyte half cells with bare copper anode, Au-on-Cu anode, and Pt-on-Cu anode; and (B) Coulombic efficiency for the polymer electrolyte half cells.

### Results and Implications

Cycling (FIG. 9) shows plating and stripping of Li metal for Bare Cu. In contrast, Au-on-Cu and Pt-on-Cu show alloying followed by Li plating during charging, and Li stripping followed by de-alloying during discharge. The insets show the nucleation region of the Li plating curves, with bare Cu having the highest overpotential. Higher overpotentials lower the voltage efficiency of the battery, so electrodes with alloys will take less power to charge.

FIG. 10, Panel A, shows that higher overpotentials lower the voltage efficiency of the battery, so electrodes with alloys will take less power to charge. FIG. 10, Panel B, shows that quantified Coulombic efficiency (CE=discharge capacity/charge capacity) for the metal thin film anodes were higher than for bare copper anodes, meaning that the metal thin film electrodes have greater discharge capacity per cycle and will have longer lifetimes compared to bare Cu.

### Example 4. Evaluation of Polymer Electrolyte Half Cells with Al-on-Cu Anodes

Polymer electrolyte half cells were prepared in 2032 coin cell format, with 1 cm² area electrodes, 250 μm lithium foil, 50 μm thick solid polymer electrolyte as electrolyte and separator (LiTFSI in PEO with a 15:1 EO:Li mol:mol ratio) with 50 nm Al-on-Cu anodes. The cells were evaluated at 60° C.: each cell was subjected to SEI formation cycles and then at 20 and 50 μA/cm² for 10+ cycles. The experimental results are shown in FIG. 11, compared to computed theoretical results. FIG. 11 shows plots of voltage versus cycling efficiency for the Al-on-Cu polymer electrolyte cells at 10, 20, 30 and 40 μA/cm² obtained experimentally (A) compared to computational results from modeling.

### Results and Implications

The experimental results in FIG. 11, Panel A, show that Al—Li alloy formation and then lithium plating occurs during charging, and that lithium stripping followed by dealloying occurs during discharging. The modeling results in FIG. 10, Panel B, confirm this mechanism of alloying-then-plating and stripping-then-dealloying qualitatively. In addition, the observed alloy-formation charging results quantitatively match the theoretical prediction.

### Example 5. Preparation of Metal Oxide-On-Cu and Lithium Metal Oxide-On-Cu Anodes

Aluminum oxide thin films are deposited on copper foil using ALD using the following the general procedure: The substrate electrode is fixed in a heated chamber. A metal precursor gas is flowed into the chamber, depositing a single layer of metal ions on the surface. Then, a secondary gas containing oxygen (usually water) if flowed into the chamber to react with the metal species, leaving MOₓ and removing the gaseous products. This two-step cycle is repeated to achieve the desired thickness. This allows precise control of the metal amount and pinhole-free deposition at thicknesses below 10 nm. This is useful for depositing the metal conformally in a porous substrate. Many elements can be deposited in this way, although precursors can be expensive. Thin films of Al₂O₃ and ZnO were prepared using this general procedure.

This process can be modified to make lithiated metal oxides (LiM′Oₓ) by replacing the metal precursor with lithium tert-butoxide in every other M′Oₓ deposition step. This deposits LiOH, which is then reacted by the next MOₓ sequence to leave LiM′Oₓ. The amount of lithiation per other metal atom is controllable by varying the number of LiOH cycles to M′Oₓ cycles. Lithium to metal ratios of Li:M′>1 are possible for very thin films (<5 nm), while Li:M′≤0.55 is possible for any thickness. Thin films of three target lithium aluminum oxide compositions were prepared by this procedure. The actual compositions of the films were determined by X-ray Photoelectron Spectroscopy (XPS) by quantifying atomic concentrations of Li, Al, and O.

Table 2 shows experimental results for films of three target lithium aluminum oxide compositions prepared by the general procedure.

TABLE 2

| Name | Target | Actual | Actual | Actual O | Actual |
|---|---|---|---|---|---|
| Li_{0.5}AlOₓ | 1:2 Li:Al | 19% | 27% | 54% | Li_{0.70}AlO_{2.00} |
| Li₁AlOₓ | 1:1 Li:Al | 26% | 14% | 60% | Li_{1.86}AlO_{4.29} |
| Li₂AlOₓ | 2:1 Li:Al | 45% | 17% | 38% | Li_{2.65}AlO_{2.24} |

The results in Table 2 provide actual elemental content compared to the target composition, showing that lithium-rich metal oxides are possible, with Li:Al>2.5. XPS on Li₁AlOₓ films quantifying atomic concentrations of Li, Al, and O also showed that there was a fairly linear correlation between actual lithium content and nominal Li cycles during ALD deposition, indicating control over the growth process.

### Example 6. Evaluation of Liquid Electrolyte Full Cells with Lithium Aluminum Oxide-on-Cu Anodes

Electrochemical cells were prepared in 2032 coin cell format, with 1 cm² area electrodes, 12 mg/cm² cathode loading of LifePO₄, 45 μL of electrolyte (1 M LiFSI+1 M LiNO₃ in DME), the lithium aluminum oxide thin film anodes shown in Table 1 of Example 5 (Li_{y}AlOₓ-on-Cu), and a CELGARD separator. The film thicknesses were 2 to 6 nm. The cells were evaluated at room temperature (23-25° C.): each cell was subjected to a 5-hour formation cycle at 0.05 mA/cm² and then charge/discharge cycled at 1 mA/cm² for 100 cycles, and compared to similar cells in which the anode was bare copper foil.

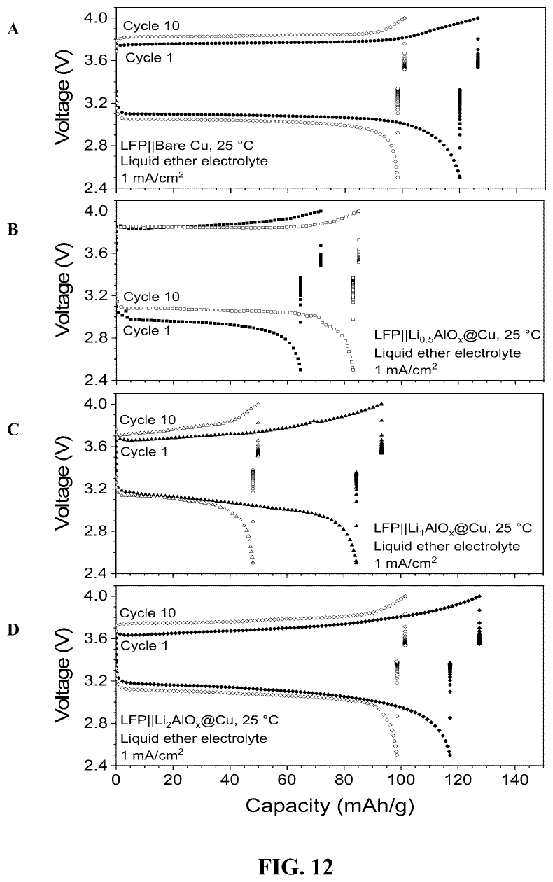

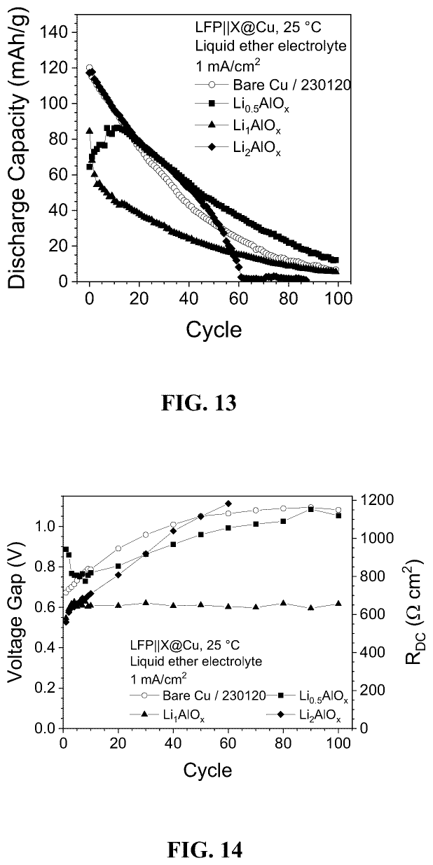

FIG. 12 shows plots of voltage versus capacity for liquid electrolyte cells at cycles 1 and 10 for cells with: (A) bare copper anode; (B) Li_{0.5}AlOₓ-on-Cu anode; (C) Li₁AlOₓ-on-Cu anode; and (D) Li₂AlOₓ-on-Cu anode. FIG. 13 shows plots of discharge capacity versus cycle for liquid electrolyte full cells with bare copper anode and Li_{y}AlOₓ-on-Cu anodes over 100 cycles. FIG. 14 shows plots of voltage gap (right vertical axis) and resistance (Ohm cm²; right vertical axis) versus cycle for liquid electrolyte full cells with bare copper anode compared to the Li_{y}AlOₓ-on-Cu anodes.

### Results and Implications

As is evident in the results shown in FIGS. 12, 13, and 14, Li_{y}AlOₓ-on-Cu anodes do not short, and are reliable and safe at high charging rates. All cells show capacity decrease over time, but this is less pronounced in Li_{y}AlOₓ-on-Cu anodes compared to bare Cu anode. Consequently, Li_{y}AlOₓ-on-Cu anode cells will have longer battery lifetimes than bare Cu anode cells. Control over the Li amount in the Li_{y}AlOₓ coating can also control lifetime. The voltage gap between charge and discharge steps increases drastically to >1 V on bare Cu, while the gap quickly plateaus to 0.6 V with Li₁AlOₓ-on-Cu anode cells. Furthermore, the voltage efficiency of the battery (the energy needed to charge vs. the energy output of the battery) is at least 40% greater for Li_{y}AlOₓ-on-Cu anode cells compared to bare Cu anode cells, since the cell resistance is lower overall. Finally, the lithium content in Li_{y}AlOₓ can limit the resistance increase over time by preventing side reactions that generate dead lithium in the cell.

### Example 7. Evaluation of Polymer Electrolyte Half Cells with Lithium Aluminum Oxide-on-Cu Anodes

Polymer electrolyte half cells were prepared in 2032 coin cell format, with 1 cm² area electrodes, 250 μm lithium foil, 50 μm thick solid polymer electrolyte as electrolyte and separator (LiTFSI in PEO with a 15:1 EO:Li mol:mol ratio) with Li_{y}AlOₓ-on-Cu anodes. The film thicknesses were 2 to 6 nm. The cells were evaluated at 60° C.: each cell was subjected to SEI formation cycles and then at 10 μA/cm^{2/1} hour steps.

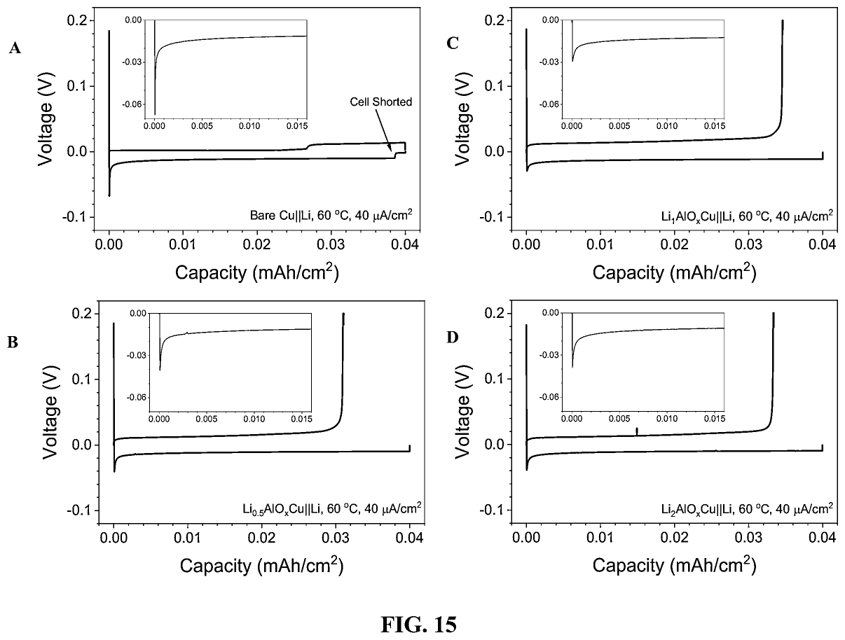

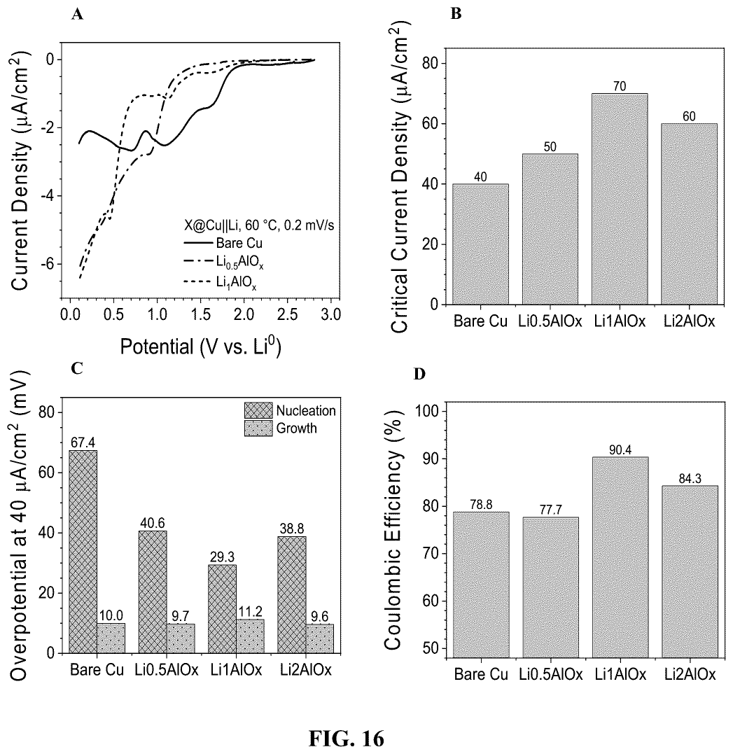

FIG. 15 shows plots of voltage versus capacity for polymer electrolyte half cells with (A) bare copper anode; (B) Li_{0.5}AlOₓ-on-Cu anode; (C) Li₁AlOₓ-on-Cu anode; and (D) Li₂AlOₓ-on-Cu anode. The insets show the nucleation region of the Li plating curves. FIG. 16 shows (A) plots of current density versus potential for polymer electrolyte half cells with bare copper anode versus Li_{y}AlOₓ-on-Cu anodes; (B) quantified nucleation and growth overpotentials for lithium plating for polymer electrolyte half cells with bare copper anode versus Li_{y}AlOₓ-on-Cu anodes; (C) critical current density for polymer electrolyte half cells with bare copper anode versus Li_{y}AlOₓ-on-Cu anodes; and (D) Coulombic efficiency for polymer electrolyte half cells with bare copper anode versus Li_{y}AlOₓ-on-Cu anodes.

### Results and Implications

Voltammetry shows lower currents for LiMOₓ layers until more negative potentials, indicating electronically insulating but ionically conducting layers. Quantified nucleation and growth overpotentials for lithium plating on different electrodes show that higher overpotentials are observed as the voltage efficiency of the battery decreases, such that LiMOₓ coatings can take less power to charge. The quantified critical current density (current at which the cell shorts and fails) results show that higher critical current density means that faster charging rates are available before cell failure, such that LiMOₓ coatings increase the charging rate of the battery. The quantified Coulombic efficiency (CE=discharge capacity/charge capacity) results indicate that LiMOₓ-on-Cu anodes result in cells with higher Coulombic efficiencies compared to bare copper anode cells, meaning that the LiMOₓ-on-Cu anodes have greater discharge capacity per cycle and will have longer lifetimes compared to bare Cu.

### Example 8. Comparison Al₂O₃-on-Cu and ZnO-on-Cu Anodes

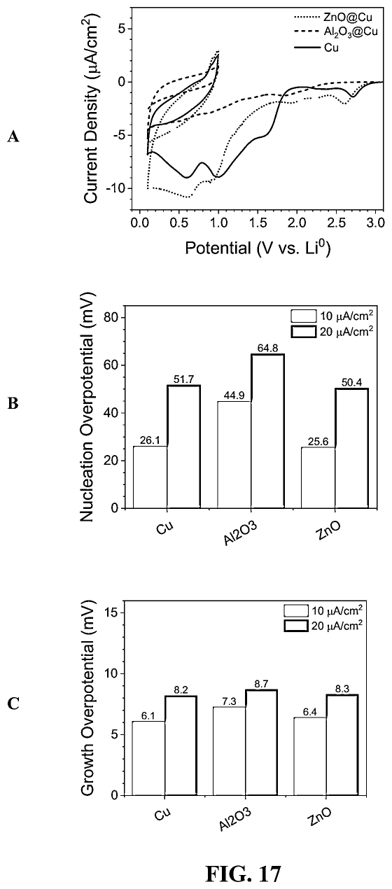

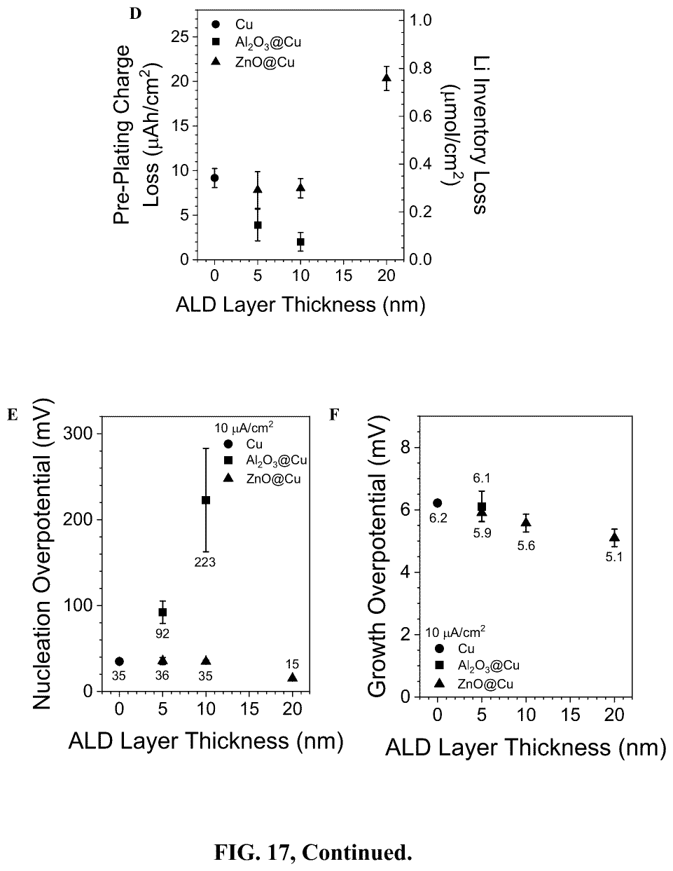

FIG. 17 provides (A) cyclic voltammetry plots, (B) nucleation overpotential graphs, (C) growth overpotential graphs for 2.8 nm Al₂O₃-on-Cu and 2.1 nm ZnO-on-Cu anodes in polymer electrolyte (LiTFSI in PEO with a 15:1 EO:Li mol:mol ratio) half cells at 10 and 20 μA/cm², compared to bare copper anode; (D) plots of pre-plating charge loss and Li inventory loss versus film layer thickness (5, 10, and 20 nm) for solid polymer electrolyte cells comprising anodes with thin films of Al₂O₃ and ZnO on copper compared to bare copper anode; (E) plots of nucleation overpotential versus film layer thickness (5, 10, and 20 nm) for solid polymer electrolyte cells comprising anodes with thin films of Al₂O₃ and ZnO on copper compared to bare copper anode; and (F) plots of growth overpotential versus film layer thickness (5, 10, and 20 nm) for solid polymer electrolyte cells comprising anodes with thin films of Al₂O₃ and ZnO on copper compared to bare copper anode.

The results in FIG. 17 show that Al₂O₃ lowers initial SEI formation current since it is electronically and ionically insulating. Pure Al₂O₃ shows greater resistances and thus higher overpotentials than bare Cu—this agrees with expectation that Al—O bond is hard to break and uniformly lithiates in this way. In comparison, ZnO has similar current to Cu since it is electronically conductive. ZnO-on-Cu shows similar overpotentials to bare Cu, which agrees with Zn—O being a softer bond to break and an easier material to lithiate and alloy with Li. FIG. 17, Panel D, demonstrates irreversible charge loss during the first charging step, which can be controlled by the choice of coating chemistry and coating thickness. In addition, higher overpotentials lower the voltage efficiency of the battery, the results in FIG. 17, Panels E and F show that the ALD coating chemistry and thickness of the coatings can be selected to lower the overpotential and improve efficiency.

### Example 9. Comparison Li_{0.5}AlOₓ-on-Cu and Li₁AlOₓ-on-Cu Anodes with Liquid Electrolyte and Low Cathode Loading

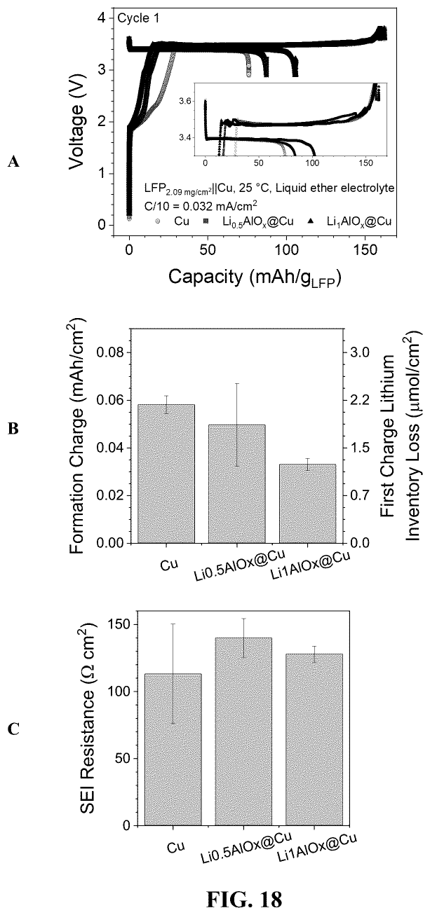

2032-type coin cells were prepared with 1 cm² area electrodes, 2.09 mg/cm² cathode loading of LifePO₄, 22 μL of electrolyte (1 M LiFSI+1 M LiNO₃ in DME), and a CELGARD separator. Cells were subjected to three 10-hour formation cycles at 0.032 mA/cm², followed by cycling at 0.032 mA/cm² for 100 cycles. FIG. 18 shows (A) plots of voltage versus capacity for liquid electrolyte cells having an anode comprising a thin film of Li₁AlOₓ or Li_{0.5}AlOₓ on a copper current collector at 12 mg/cm² cathode loading, compared to a bare copper anode at equivalent cathode loading; (B) graphs of formation charge for the Li₁AlOₓ and Li_{0.5}AlOₓ anode cells compared to bare copper anode at equivalent cathode loading; and (C) graphs of SEI resistance for the Li₁AlOₓ and Li_{0.5}AlOₓ anode cells compared to bare copper anode at equivalent cathode loading. The results in FIG. 18 demonstrate that Li_{y}AlOₓ-on-Cu (y=0.5 or 1) has a smaller pre-lithium plating charge and greater discharge capacity than bare copper. Li_{y}AlOₓ on-Cu (y=0.5 or 1) consumes two-times less lithium irreversibly during the formation step (the first charge of the battery) compared to bare Cu, allowing more capacity over time. Irreversible lithium loss decreases with increasing Li content in the coating (FIG. 18, Panel B).

SEI resistance does not vary significantly between electrodes (FIG. 18, Panel C). ALD coatings on Cu electrodes do not significantly increase the cell resistance, so they do not affect power output or charging rates while still benefiting cell lifetime.

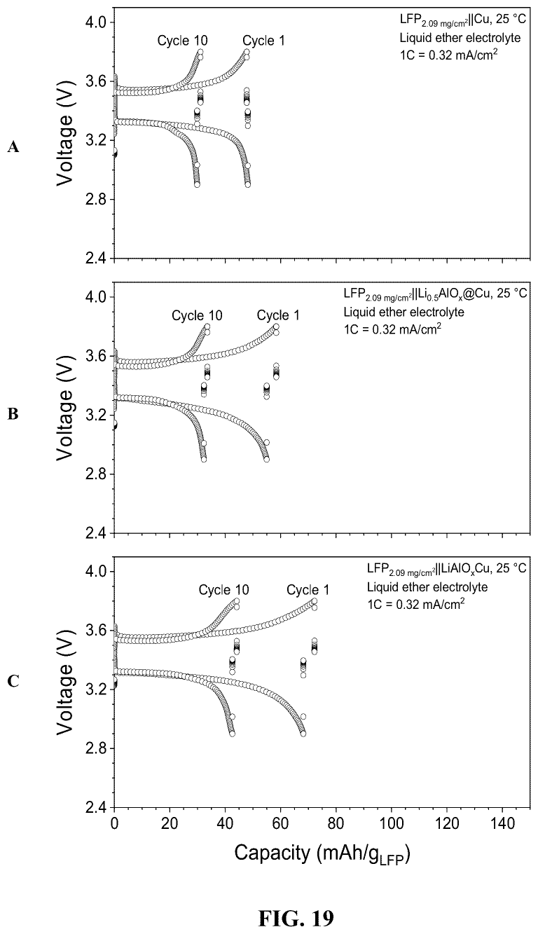

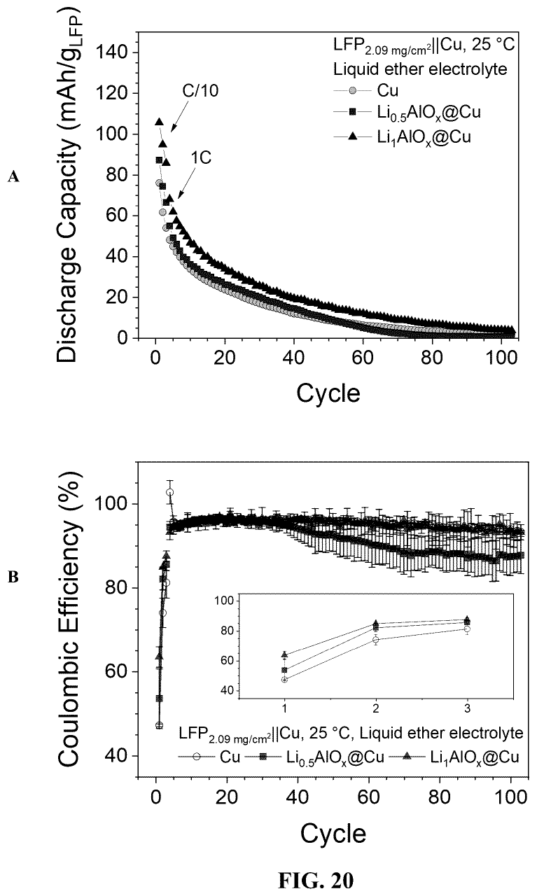

FIG. 19 shows plots of voltage versus capacity for the Li₁AlOₓ and Li_{0.5}AlOₓ anode cells (Panels C and B, respectively) compared to bare copper anode (Panel A). FIG. 20 shows (A) plots of discharge capacity versus cycle number, and (B) plots of Coulombic efficiency versus cycle number, for all three cells. The results in FIGS. 19 and 20 show that Li_{y}AlOₓ-on-Cu has a smaller pre-lithium plating charge and greater discharge capacity. Li_{y}AlOₓ consumes two-times less lithium irreversibly during the formation step (the first charge of the battery), allowing more capacity over time. All cells show capacity decrease over time, but this is less pronounced in Li_{y}AlOₓ-on-Cu vs. bare Cu due to the initially higher capacity following formation steps, indicating that Li_{y}AlOₓ-on-Cu cells will have longer battery lifetimes bare Cu cells.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A rechargeable electrochemical cell comprising, in a fully discharged state: a cathode and a layered anode with an electrolyte therebetween; wherein the cathode comprises an electrochemically reactive first metal selected from the group consisting of Li, Na, Mg, and Zn; the layered anode comprises an electrically conductive substrate and a reactive film on a surface of the substrate in contact with the electrolyte; the reactive film comprises (a) an elemental metal or a semimetal selected from the group consisting of B, Mg, Al, Ca, Zn, Ga, Ge, As, Sr, Rh, Pd, Ag, Cd, In, Sn, Sb, Te, Ba, Ir, Pt, Au, Hg, TI, Pb, and Bi, or (b) an oxide of a metal or a semimetal selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi; and the electrolyte comprises ions of the reactive metal of the cathode; wherein the reactive film alloys with, forms a mixed phase with, or reacts with, the first metal from the cathode during charging of the cell, and releases the first metal back to the cathode during discharging of the cell to reconstitute the reactive film; and the reactive film has a thickness of about 1 to 100 nm.

2. The electrochemical cell of claim 1, wherein the cathode comprises lithium and the reactive film comprises at least one elemental metal selected from the group consisting of Mg, Al, Ga, Sn, In, Ag, Au, Pt, Zn, Pb, and Bi.

3. The electrochemical cell of claim 2, wherein the cathode comprises lithium and the reactive film comprises an oxide of at least one metal or semimetal selected from the group consisting of B, Ti, Zr, Nb, Zn, Al, Ga, In, and Sn; and the metal oxide optionally also comprises lithium ions.

4. The electrochemical cell of claim 1, wherein the reactive film of the anode has a three-dimensional, non-planar morphology.

5. A rechargeable lithium electrochemical cell comprising, in a fully discharged state: a cathode comprising lithium and a layered anode with a lithium electrolyte therebetween; wherein the layered anode comprises a metal substrate and a metal or semimetal film having a thickness of about 1 nm to about 100 nm on a surface of the substrate in contact with the electrolyte; wherein the film comprises at least one elemental metal or semimetal selected from the group consisting of B, Mg, Al, Ca, Zn, Ga, Ge, As, Sr, Rh, Pd, Ag, Cd, In, Sn, Sb, Te, Ba, Ir, Pt, Au, Hg, Tl, Pb, and Bi; the film alloys with, or forms a mixed phase with, lithium from the cathode during charging of the cell, and releases the lithium back to the cathode during discharging of the cell to reconstitute the film.

6. The electrochemical cell of claim 5, wherein the substrate of the anode is a copper foil or mesh.

7. The electrochemical cell of claim 5, wherein the film comprises at least one metal selected from the group consisting of Mg, Al, Ga, Sn, In, Ag, Au, Pt, Zn, Pb, and Bi.

8. The electrochemical cell of claim 5, wherein the film comprises at least one metal selected from the group consisting of Al, Au, and Pt.

9. The electrochemical cell of claim 5, wherein the film additionally comprises at least some lithium.

10. The electrochemical cell of claim 5, wherein the lithium electrolyte is a liquid electrolyte comprising a lithium electrolyte salt in a non-aqueous aprotic solvent; the electrochemical cell further comprises a porous separator between the cathode and the anode; and the separator is immersed in, and permeable to, the liquid electrolyte.

11. The electrochemical cell of claim 5, wherein the lithium electrolyte is a polymer electrolyte comprising a lithium electrolyte salt dispersed in a polymer matrix.

12. The electrochemical cell of claim 11, wherein the polymer electrolyte further comprises a non-aqueous aprotic solvent dispersed in the polymer matrix.

13. The electrochemical cell of claim 5, wherein the metal or semimetal film of the anode has a three-dimensional, non-planar morphology.

14. A rechargeable lithium electrochemical cell comprising, in a fully discharged state: a cathode comprising lithium and a layered anode with a lithium electrolyte therebetween; wherein the layered anode comprises a metal substrate and a lithium-reactive oxide film having a thickness of about 1 nm to about 100 nm on a surface of the substrate in contact with the electrolyte; wherein the oxide film comprises an oxide of a metal or a semimetal selected from the group consisting of Li, Be, B, Al, Sc, Ti, V, Cr, Mn, Fe, Co, Ni, Cu, Zn, Ga, Ge, As, Y, Zr, Nb, Mo, In, Sn, Sb, Te, La, Ce, Hf, Ta, W, Pb, and Bi; the film reacts with lithium from the cathode during charging of the cell, and releases the lithium back to the cathode to reconstitute the metal oxide film during discharging of the cell.

15. The electrochemical cell of claim 14, wherein the substrate of the anode is a copper foil or mesh.

16. The electrochemical cell of claim 14, wherein the lithium-reactive oxide film comprises an oxide of at least one metal or semimetal selected from the group consisting of B, Ti, Zr, Nb, Zn, Al, Ga, In, and Sn.

17. The electrochemical cell of claim 14, wherein the metal oxide or semimetal oxide also comprises lithium ions.

18. The electrochemical cell of claim 17, wherein the film comprises a lithium aluminum oxide.

19. The electrochemical cell of claim 14, wherein the lithium electrolyte is a liquid electrolyte comprising a lithium electrolyte salt in a non-aqueous aprotic solvent; the electrochemical cell further comprises a porous separator between the cathode and the anode; and the separator is immersed in, and permeable to, the liquid electrolyte.

20. The electrochemical cell of claim 14, wherein the lithium electrolyte is a polymer electrolyte comprising a lithium electrolyte salt dispersed in a polymer matrix.

21. The electrochemical cell of claim 20, wherein the polymer electrolyte further comprises a non-aqueous aprotic solvent dispersed in the polymer matrix.

22. The electrochemical cell of claim 14, wherein the oxide film of the anode has a three-dimensional, non-planar morphology.
